(19) United States
(12) Patent Application Publication
(10) Pub. No.: US 2021/0362761 A1
(43) Pub. Date: Nov. 25, 2021

(54) CABIN CARGO COMPARTMENTS

(71) Applicant: B/E Aerospace, Inc., Winston Salem, NC (US)

(72) Inventor: James Page, Milton Keynes (GB)

(21) Appl. No.: 17/327,470

(22) Filed: May 21, 2021

Related U.S. Application Data
(60) Provisional application No. 63/028,489, filed on May 21, 2020.

(51) Int. Cl. B62B 3/00; B62B 5/00; A62C 3/00; A62C 3/07

(52) U.S. Cl. CPC B62B 3/00; A62C 3/07; A62C 3/002; B62B 5/00

(57) ABSTRACT

A cargo compartment for use in a transport vehicle, the cargo compartment comprising a cargo compartment housing configured and adapted to comply with at least one regulatory requirement of the transport vehicle. The cargo compartment includes wheels attached to the cargo compartment housing. A cargo compartment system for use in a transport vehicle includes a cargo compartment. The cargo compartment includes a cargo compartment housing configured and adapted to comply with at least one regulatory requirement of the transport vehicle, and wheels attached to the cargo compartment housing. The cargo compartment system includes a seat track having at least one fastener. The cargo compartment housing is configured and adapted to couple to the seat track and be secured to the seat track via the at least one fastener.

### CROSS-REFERENCE TO RELATED APPLICATION

This application claims priority to and the benefit of U.S. Provisional Application No. 63/028,489, filed May 21, 2020, the entire contents of which are herein incorporated by reference in their entirety.

### BACKGROUND

### 1. Field

The present disclosure relates generally to cargo compartments in cabin areas, and more particularly to such cargo compartments and systems aboard aircraft.

### 2. Description of Related Art

The COVID-19 outbreak has reduced the demand for passenger travel on airlines, boats, trains, etc. In particular, some airlines are now re-purposing idle passenger aircraft to carry freight in their cabins. In an effort to quickly adapt to the ever-changing landscape, the practices implemented for using passenger vehicles, such as passenger aircraft, for freight may not be the most efficient or most practical long-term solutions. Some of these practices rely on using cargo bags secured by straps, netting or the like, or utilizing full cargo pallets secured by straps. Cargo bags can be inefficient to carry on- and off-board, while pallets can be difficult to navigate on- and off-board due to the size of cabin access doors. These solutions also rely on cabin crew manually inspecting cargo in-flight to ensure appropriate fire remediation can be taken, e.g. by fire extinguisher.

There is an ongoing need for improved systems and methods to utilize passenger aircraft for freight, while ensuring flexibility, efficiency, and safety. This disclosure provides a solution for this.

### SUMMARY

A cargo compartment for use in a transport vehicle, the cargo compartment comprising a cargo compartment housing configured and adapted to comply with at least one regulatory requirement of the transport vehicle. The cargo compartment includes wheels attached to the cargo compartment housing.

In some embodiments, the cargo compartment housing includes at least one of a fire suppression system or a flame resistant material. The flame resistant material can be a flame resistant plastic material. The fire suppression system can include at least one of a particulate detector or a spray system. The cargo compartment can include at least one cargo compartment door operatively connected to the cargo compartment housing configured and adapted to secure cargo within the cargo compartment housing. The at least one regulatory requirement of the transport vehicle can include a fire suppression regulatory requirement.

In accordance with another aspect, a cargo compartment system for use in a transport vehicle includes a cargo compartment. The cargo compartment includes a cargo compartment housing configured and adapted to comply with at least one regulatory requirement of the transport vehicle. The cargo compartment system includes a seat track having at least one fastener. The cargo compartment housing is configured and adapted to couple to the seat track and be secured to the seat track via the at least one fastener.

In some embodiments, the seat track is configured and adapted to be integrated within a cabin floor. The cargo compartment housing and cargo compartment can be similar to those described above.

In accordance with another aspect, a method for retrofitting a passenger cabin with cargo compartments includes removing existing passenger seating from seat tracks in the passenger cabin. The method includes rolling at least one cargo compartment into the passenger cabin. The method includes securing the at least one cargo compartment onto the seat tracks.

In some embodiments, the method includes adding fasteners to the seat tracks. Securing the at least one cargo compartment onto the seat tracks can include securing the at least one cargo compartment in place with fasteners. The cargo compartment can be the same as that described above. The seat tracks can include at least one fastener. The cargo compartment can include a cargo compartment including wheels attached. Locking the at least one cargo compartment to the seat tracks includes coupling the locking bracket of the cargo compartment to the seat track with the at least one fastener.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic front view of a cross-section of an embodiment of a cargo compartment system for use in a transport vehicle constructed in accordance with the present disclosure, showing a plurality of cargo compartments attached to a seat track;

FIG. 2 is a schematic perspective view of one of the cargo compartments of FIG. 1, showing the cargo compartment housing and door;

FIG. 3 is a schematic perspective view of another embodiment of a cargo compartment for use in a cargo compartment system constructed in accordance with the present disclosure, showing a larger cargo compartment housing than that of FIG. 2;

FIG. 4 is a schematic perspective view of the cargo compartment system of FIG. 1, showing a passenger cabin with seat tracks; and

FIG. 5 is a schematic perspective view of the cargo compartment of FIG. 2, showing the cargo compartment door in an open position to show the fire suppression system.

### DETAILED DESCRIPTION

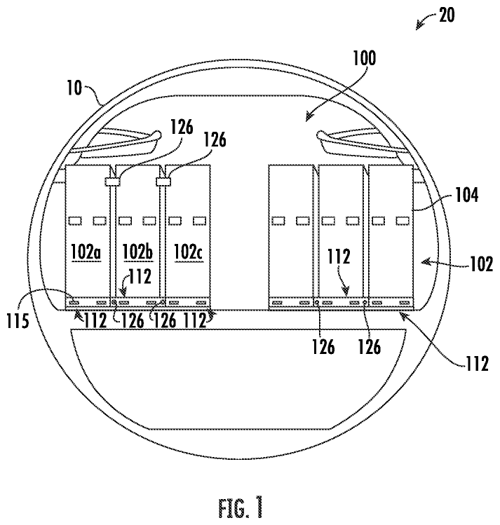

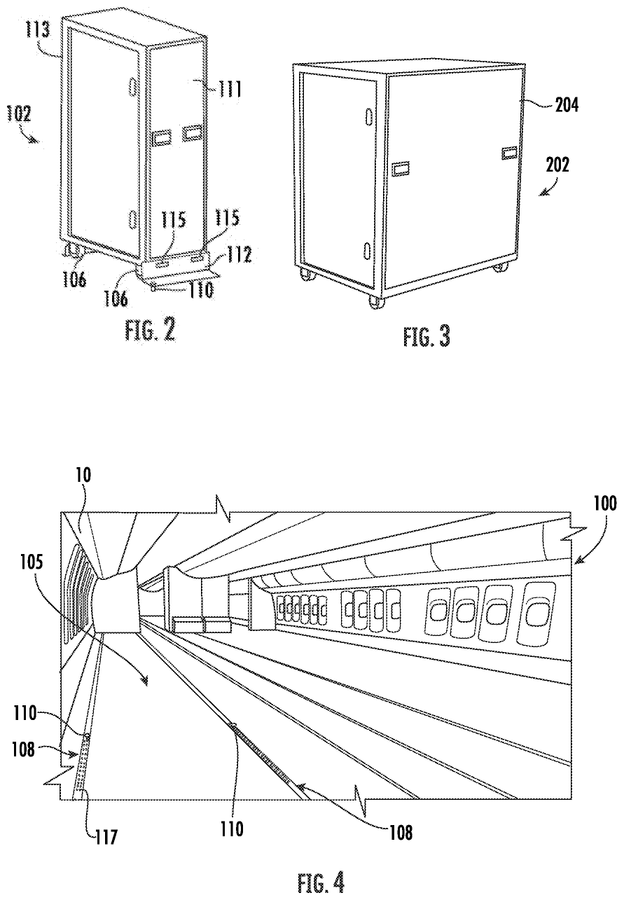

Reference will now be made to the drawings wherein like reference numerals identify similar structural features or aspects of the subject disclosure. For purposes of explanation and illustration, and not limitation, an embodiment of a system in accordance with the disclosure is shown in FIG. 1 and is designated generally by reference character 100. Other embodiments of systems in accordance with the disclosure, or aspects thereof, are provided in FIGS. 2A-5, as will be described. The systems and methods described herein can be used to provide flexible and efficient cargo transport options within passenger cabins, e.g. a cabin 10 within aircraft or other transport devices, such as trains, ships, or the like, as well as providing integral fire suppression, or meeting other regulatory requirements as needed for a given type of carrier or vehicle.

As shown in FIGS. 1-2, and 4, a cargo compartment system 100 for use in a transport vehicle, e.g. an aircraft 20, includes a plurality of cargo compartments 102. Each cargo compartment 102 includes a cargo compartment housing 104. Each cargo compartment housing 104 is made from a flame resistant plastic material. Each cargo compartment housing 104 includes wheels 106 attached to the cargo compartment housing 104 such that the cargo compartment 102 can be loaded off-board and then wheeled onto the aircraft 20 in an efficient manner. This ensures that spacing requirements between crew members, e.g. in view of the COVID-19 outbreak, can be maintained while loading. The cargo compartment system 100 includes a plurality of seat tracks 108 having at least one fastener 110 and at least one hole/aperture 117 for mating the fastener 110 to the track 108. The seat tracks 108 are configured and adapted to be integrated within a cabin floor 105. The cargo compartment 102 is configured and adapted to couple with the seat track 108 and be secured to the seat track 108 via the at least one fastener 110 and a locking bracket 112 of the cargo compartment 102. Those skilled in the art will readily appreciate that cargo compartment system 100 can employ the materials and methods currently used to build interior structures on the given vehicle for which cargo compartment system 100 is to be used. For example, in passenger aircraft 20, the cargo compartments 102 can be constructed from the same materials and methods used to build aircraft interior monuments, e.g. galleys, and the like. In some embodiments, cargo compartments 102 can be based on the existing galley construction for the A350. Those skilled in the art, however, will readily appreciate that compartments 102 can be utilized on a variety of aircraft or other vehicles, including other CS-25 aircraft.

As shown in FIGS. 2 and 4-5, cargo compartment 102 includes two locking brackets 112. A first is positioned across a front side 111 of the cargo compartment 102 and a second is positioned across a back side 113 of the cargo compartment 102. The locking bracket 112 is an L-shaped bracket with a first side of the “L” connecting to the cargo compartment 102 via a fastener, e.g. a locking cleat 115, or the like, and a second side of the “L” shaped bracket connecting to the seat tracks 108 via the fastener 110 and an aperture 119 in the locking bracket 112. The flexibility and adaptability of the cargo compartments 102 allow for full or partial conversion back and forth between freight and passenger operation. Cargo compartments 102 can be separately wheeled onto the vehicle, making it easier to fit through the vehicle access door, and then can be fastened together as described below.

As shown in FIG. 1, in embodiments where a middle cargo compartment 102, e.g. cargo compartment 102b, may not have seat tracks 108 to couple with directly, cargo compartment 102b may be secured to the adjacent cargo compartments 102a and 102c. Cargo compartment 102b can be fastened to adjacent compartments 102a and 102b by way of a mechanical fastener 126, e.g., a bolt, screw or the like. In lieu of (or in addition to) bolt 126 at the top of cargo compartments 102, bolt or screw 126 can connect the adjacent compartments, e.g. 102a and 102b, by being threaded or inserted through holes of overlapping locking brackets 112 of the adjacent compartments 102a and 102c.

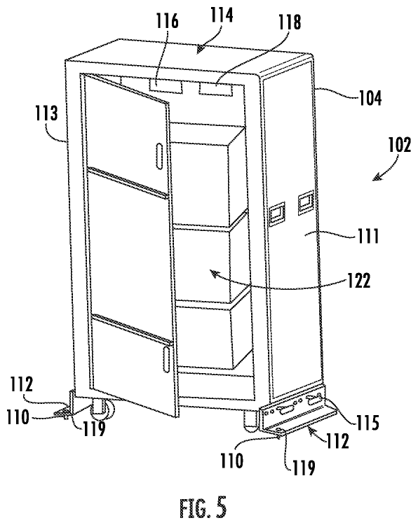

As shown in FIG. 5, each cargo compartment 102 includes at least one cargo compartment door 120 operatively connected to the cargo compartment housing 104 configured and adapted to secure cargo 122 within the cargo compartment housing 102. Each cargo compartment housing 104 includes a fire suppression system 114 to overcome the potential fire risk and comply with regulations typically governing freight in cargo aircraft. The fire suppression system 114 includes a particulate detector 116 and a spray system 118. The fire suppression system 114 can be active, in the form of the detector and spray system 118, or passive, in the form of flame resistant materials, e.g. the flame resistant plastic discussed above. This fire suppression system 114 within each cargo compartment 102 allows for a standard passenger aircraft retrofitted with the cargo compartments 102 to comply with the appropriate fire regulations that govern cargo aircraft, but may not govern passenger aircraft in the same manner. System 114 may also negate the need for a cabin crew member to walk around with a fire extinguisher.

As shown in FIG. 3, an another embodiment of a cargo compartment 202 is shown. Cargo compartment 202 is substantially the same as compartment 102 and can be used in a cargo compartment system, 100, as described above. The primary difference with compartment 202 is that it is wider and instead of requiring three separate compartments 102 positioned across a seat track, e.g. seat track 108, a single compartment 202 could be used. Larger compartments may reduce turn-around time and cargo handling time. Those skilled in the art will readily appreciate that in some embodiments, the cargo compartments 102 or 202 can be scaled to give from 0.5 m³ to 2.0 m³ (17.66 ft³ to 70.63 ft³) of stowage. Those skilled in the art will readily appreciate that an operator can use larger or smaller sizes depending on need and cabin layout.

A method for retrofitting a passenger cabin, e.g. cabin 10, with cargo compartments, e.g. cargo compartments 102, includes removing existing passenger seating from seat tracks, e.g. seat tracks 108, in the passenger cabin. If not already included on the seat track, the method includes adding fasteners, e.g. fasteners 110, locking cleats or the like, to the seat tracks. The method includes rolling at least one cargo compartment into the passenger cabin. The method includes locking a locking bracket, e.g. locking bracket 112, to the cargo compartment via a fastener, e.g. a locking cleat 115. The method includes locking the at least one cargo compartment onto the seat tracks by locking the at least one cargo compartment in place with the fasteners, e.g. fasteners 110. The method includes engaging the fasteners and at least one hole, e.g. hole 117, of the seat track, and an aperture, e.g. aperture 119, of the locking bracket of the cargo compartment. As no permanent alterations to the cabin or passenger area are made, the vehicle, e.g. the aircraft 20, can be returned to passenger service at a later date. Those skilled in the art will readily appreciate that while the systems and methods above are described in the context of passenger cabins on aircraft, this system and method can be utilized in other passenger cabins, such as those in trains, boats, busses, etc.

The methods and systems of the present disclosure, as described above and shown in the drawings, provide for systems and methods that allow for quick, easy and safe loading and transport of cabin cargo through the utilization of roll on-roll off cargo compartments that can be filled and emptied off-vehicle then loaded and secured during travel by fasteners, such as locking cleats, or the like, pre-installed on the existing passenger seat tracks. Systems and methods of the present disclosure provide an economical and flexible option for carriers to change between passenger carrier and freight carrier. While the apparatus and methods of the subject disclosure have been shown and described, those skilled in the art will readily appreciate that changes and/or modifications may be made thereto without departing from the scope of the subject disclosure.

What is claimed is:

1. A cargo compartment for use in a transport vehicle, the cargo compartment comprising:
a cargo compartment housing configured and adapted to comply with at least one regulatory requirement of the transport vehicle; and
wheels attached to the cargo compartment housing.

2. The cargo compartment as recited in claim 1, wherein the cargo compartment housing includes a flame resistant material, wherein the flame resistant material is a flame resistant plastic material.

3. The cargo compartment as recited in claim 1, wherein the cargo compartment housing includes a fire suppression system, wherein the fire suppression system includes at least one of a particulate detector or a spray system.

4. The cargo compartment as recited in claim 1, further comprising at least one cargo compartment door operatively connected to the cargo compartment housing configured and adapted to secure cargo within the cargo compartment housing.

5. The cargo compartment as recited in claim 1, wherein the cargo compartment housing includes at least one of a fire suppression system or a flame resistant material.

6. A cargo compartment system for use in a transport vehicle, the cargo compartment system comprising:
a cargo compartment including:
a cargo compartment housing configured and adapted to comply with at least one regulatory requirement of the transport vehicle; and
wheels attached to the cargo compartment housing; and
a seat track having at least one fastener, wherein the cargo compartment housing is configured and adapted to couple to the seat track and be secured to the seat track via the at least one fastener.

7. The cargo compartment system as recited in claim 6, wherein the seat track is configured and adapted to be integrated within a cabin floor.

8. The cargo compartment system as recited in claim 6, wherein the cargo compartment housing includes a flame resistant material, wherein the flame resistant material is a flame resistant plastic material.

9. The cargo compartment system as recited in claim 6, wherein the cargo compartment housing includes a fire suppression system, wherein the fire suppression system includes at least one of a particulate detector or a spray system.

10. The cargo compartment system as recited in claim 6, wherein the cargo compartment includes at least one cargo compartment door operatively connected to the cargo compartment housing configured and adapted to secure cargo within the cargo compartment housing.

11. The cargo compartment system as recited in claim 6, wherein the cargo compartment housing includes at least one of a fire suppression system or a flame resistant material.

12. A method for retrofitting a passenger cabin with cargo compartments, the method comprising:
removing existing passenger seating from seat tracks in the passenger cabin;
rolling at least one cargo compartment into the passenger cabin; and
securing the at least one cargo compartment onto the seat tracks.

13. The method as recited in claim 12, further comprising adding fasteners to the seat tracks.

14. The method as recited in claim 12, wherein securing the at least one cargo compartment onto the seat tracks includes securing the at least one cargo compartment in place with fasteners.

15. The method as recited in claim 12, wherein the cargo compartment includes a cargo compartment housing including at least one of a fire suppression system or a flame resistant material, and wheels attached to the cargo compartment housing.

16. The method as recited in claim 15, wherein the cargo compartment housing includes the flame resistant material, wherein the flame resistant material is a flame resistant plastic material.

17. The method as recited in claim 15, wherein the cargo compartment housing includes the fire suppression system, wherein the fire suppression system includes at least one of a particulate detector or a spray system.

18. The method as recited in claim 12, wherein the seat tracks include at least one fastener, wherein the cargo compartment includes a locking bracket, wherein locking the at least one cargo compartment to the seat tracks includes coupling the locking bracket of the cargo compartment to the seat track with the at least one fastener.

19. The method as recited in claim 12, wherein the cargo compartment includes at least one cargo compartment door operatively connected to the cargo compartment housing configured and adapted to secure cargo within the cargo compartment housing.
